(19) United States
(12) Patent Application Publication
(10) Pub. No.: US 2007/0014577 A1
(43) Pub. Date: Jan. 18, 2007

(54) OPTICAL COMMUNICATIONS APPARATUS AND METHOD COMPATIBLE WITH ELECTRICAL COMMUNICATIONS SYSTEMS

(75) Inventors: Howard Austerlitz, Stony Brook, NY (US); Ronald Bueter, Cary, NC (US); Avi Korenshtein, Commack, NY (US)

Correspondence Address: DON W. BULSON (PARKER HANNIFIN);RENNER, OTTO, BOISSELLE & SKLAR, LLP, 1621 EUCLID AVENUE / 19TH FLOOR, CLEVELAND, OH, 44115, US

(73) Assignee: PARKER-HANNIFIN CORPORATION, Cleveland, OH (US)

(21) Appl. No.: 11/456,899

(22) Filed: Jul. 12, 2006

Related U.S. Application Data
(60) Provisional application No. 60/698,650, filed on Jul. 12, 2005.

(51) Int. Cl. H04B 10/00

(52) U.S. Cl. 398/140

(57) ABSTRACT

An optical communications link for an electrical communications system, e.g., an ARINC 429 protocol system, includes a first logic device to convert an input signal of a given level to a first electrical signal of a duration corresponding to such level, a first optical device (transmitter) presenting an optical signal of a duration corresponding to such first electrical signal, a second optical device (receiver) to convert the optical signal to a second electrical signal of a duration representative of the duration of the optical signal, an optical coupling between the optical devices, and a second logic device to convert the second electrical signal to an output electrical signal having a level representative of the duration of the optical signal. A communications system including electrical communications input and output devices, the optical and an optical communications link coupled between those devices. A method of coupling electrical signals includes converting or encoding electrical signals that are provided at multiple levels in an electrical communications system to optical signals that have a duration respectively representative of the corresponding electrical signal level, transmitting the optical signals, and decoding the optical signals. The converting/encoding and the decoding may be accomplished using hardware logic without the need for a processor and associated software.

### RELATED APPLICATIONS

This application claims the benefit of U.S. Provisional Application No. 60/698,650 filed Jul. 12, 2005.

### FIELD OF THE INVENTION

The present invention relates generally, as indicated, to optical communications apparatus and method compatible with electrical communications systems, and the invention relates to optical communications apparatus and method compatible with and substantially transparent to electrical communications systems used in aircraft, such as, for example the ARINC 429 standard electrical communications systems.

### BACKGROUND OF THE INVENTION

Many optical communications protocols via fiber optics are well established. In the field of avionics, some of the standards covering optical communications include ARINC 629, ARINC 664 and ARINC 763; the latter two standards cover the use of optical Ethernet in aircraft, such as, for example, 100-Base FX and 1,000-Base FX. These optical communications protocols and systems using them typically require relatively complex hardware and software. The hardware, for example, may include one or more processors, memory devices, input/output devices, etc., and the software required to operate the hardware to implement the respective communications protocols. As new communications protocols are developed, the hardware and/or the software may need to be qualified for use in environments such as aircraft. Also, ARINC 801-806 communications protocols are under development; these define fiber optic hardware in aircraft.

The ARINC 429 communications protocol or standard is an electrical communications system that is used in aircraft. Systems that use the ARINC 429 protocol typically use an electrical conductor, e.g., a wire, to connect electrical signals in the ARINC 429 electrical signaling format from one device to another device in an aircraft, for example. If communications is required in both directions, then two wires are required, one for each direction. For simplicity of description herein the devices between which communications is provided using ARINC 429 communications protocol are referred to below as “system devices.” The system devices may be any devices of an aircraft, for example, or of other systems in which such communications may be desired.

It would be useful to provide new avionics equipment backwards compatibility with the ARINC 429 standard while still being able to use fiber optics communications. ARINC 429 protocol is suitably fast for its uses, but it is not as high speed as some other communications systems. ARINC protocol communications have been reliable for use in aircraft.

The ARINC 429 electrical signaling format is a 3-level system. For example, a bit, e.g., a bit of data, can either be positive (high), negative (low) or ground (off). Although electrical signals can be used to represent the three levels of the ARINC 429 electrical signaling format, the on/off character of optical signals is not directly amenable to a 3-level system.

### SUMMARY OF THE INVENTION

An aspect of the invention relates to an optical communications link for use in an electrical communications system, including a first logic device operative to convert or to encode an input signal of a given level to an a first electrical signal of a duration corresponding to such level, a first optical device presenting an optical signal of a duration corresponding to such first electrical signal, a second optical device operative to convert the optical signal to a second electrical signal of a duration representative of the duration of the optical signal, an optical coupling between the first and second optical devices, and a second logic device operative to convert or to decode the second electrical signal to an output electrical signal having a level that is representative of the duration of the optical signal.

An aspect of the invention relates to an ARINC 429 communications system for an aircraft, including a first electrical signaling device providing electrical signals based on ARINC 429 protocol, an electrical signal device either proximate or relatively remote from the first electrical signaling device and responsive to electrical signals based on ARINC 429 protocol, and an optical communications link between the first electrical signaling device and the electrical signal device to communicate between the two using optical signals that have respective durations representative of the level of such electrical signals. According to another aspect, the electrical signal device may be an electrical signaling device to provide electrical signals.

An aspect of the invention relates to an optical communications link, including input logic receiving multi-level electrical communications signals and providing optical output signals of respective durations corresponding to the levels respective electrical communication signals, output logic receiving such optical output signals and providing multi-level electrical signals of respective levels corresponding to the durations of the respective optical output signals, and an optical link between the input logic and the output logic.

An aspect of the invention relates to a method of converting electrical signals that are provided at three (3) or more levels (e.g., two levels different than ground or zero) for use in an electrical communications system to optical signals, including converting the electrical signals to or representing them as optical signals that have a duration respectively representative of the corresponding electrical signal level.

An aspect of the invention relates to a method of converting electrical signals that are provided at two (2) or more levels (e.g., two different voltages or a voltage level and a ground or zero volts, for example, in a conventional TTL data stream) for use in an electrical communications system or in some other data transmission system to optical signals, including converting the electrical signals to or representing them as optical signals that have a duration respectively representative of the corresponding electrical signal level.

An aspect of the invention relates to a method of converting electrical signals to optical signals, including sensing the level of respective electrical signals, and providing optical signals that have a duration representative of the corresponding electrical signal.

In the description hereof reference is made to electrical signals of respective levels. The levels may be voltages, for example, or the levels may be some other measurement or value of the electrical signals. As an example, the levels of an ARINC 429 protocol system are, respectively, a positive voltage of a given magnitude above zero volts or ground (this positive voltage sometimes referred to as the “high level”), a negative voltage of a given magnitude below zero volts or ground (this negative voltage sometimes is referred to as the “low level”) and zero volts or ground. In the description hereof reference is made to an ARINC 429 protocol system and to using signals that are, respectively, high, low and zero (or ground) as are provided according to ARINC 429 protocol. However, it will be appreciated that the invention hereof may be used in other communications systems and with protocols other than ARINC 429. Also, it will be appreciated that the invention may be used with systems in which the number of levels is more than three. Further, it will be appreciated that although the word “level” is used, e.g., as in three voltage levels of an ARINC 429 protocol, reference to “level” also may include the possibility of a range of values, e.g., a range of voltages. For example, the high voltage may be any voltage within a range of voltages, the low voltage may be any voltage in a range of voltages, and the other level(s) may be other voltage or voltages in respective ranges, etc.

One or more of the above and other aspects, objects, features and advantages of the present invention are accomplished using the invention described and claimed herein. Also it will be appreciated that one or more parts or features, etc., shown in one embodiment or drawing may be used in the same or a similar way in another embodiment.

To the accomplishment of the foregoing and related ends, the invention, then, comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed.

Although the invention is shown and described with respect to one or more embodiments, it is evident that equivalents and modifications will occur to others skilled in the art. The present invention includes all such equivalents and modifications, and is limited only by the scope of the claims.

### BRIEF DESCRIPTION OF THE DRAWINGS

In the annexed drawings:

FIG. 1 is an example of a 32-Bit ARINC 429 word format;

FIG. 2 is an example of a 32-Bit ARINC 429 word allocation for binary coded decimal data;

FIG. 3 is a schematic block diagram of an optical communications link for ARINC 429 data in accordance with an embodiment of the present invention;

FIG. 4 is an example illustrating PDM (pulse duration modulation (or pulse width modulation)) data encoding definitions for ARINC 429 data;

FIG. 5 is an example of PDM encoder timing;

FIG. 6 is an example of PDM decoder timing;

FIG. 7 is a schematic block diagram of a bidirectional optical communications link for ARINC 429 data; and

FIG. 8 is a schematic block diagram of an optical communications link for ARINC 429 data and including a filter in accordance with an embodiment of the present invention.

### DETAILED DESCRIPTION

Referring, now, to the drawings, and initially to FIG. 1 and to the examples of the invention presented below with respect to the several drawing figures in which like reference numerals designate like parts in the several figures, the invention is presented with respect to maintaining the standard ARINC 429 data protocol of 32-bit words, an example of which is illustrated at 1, which contain nineteen (19) bits of data at 1a or twenty-one (21) bits of data at 1b. In addition to the nineteen (19) bits of data or twenty-one (21) bits of data 1c, 1d, respectively, each of the data words 1a, 1b also includes nine (9) label bits and additional status bits, parity bit, etc., as is conventional for ARINC 429 protocol data and which are indicated in the drawing of FIG. 1. Thus, FIG. 1 illustrates an example of the ARINC 429 data protocol for the electrical bits thereof. Each of the bits is represented by a positive voltage level or a negative voltage level, each relative to ground or zero volts, as is seen in FIG. 1. Thus, the example illustrated in FIG. 1 represents a three level system in which there are high (positive-going) data bits, low (negative-going data bits) and ground or zero volts. One might also consider the example of FIG. 1 a two level system in that there are high bits and low bits relative to ground. It will be appreciated that the invention also may be used in connection with other data protocols that have two or more levels in addition to ground. The invention also may be used with two level systems in which one is ground or both levels are non-ground.

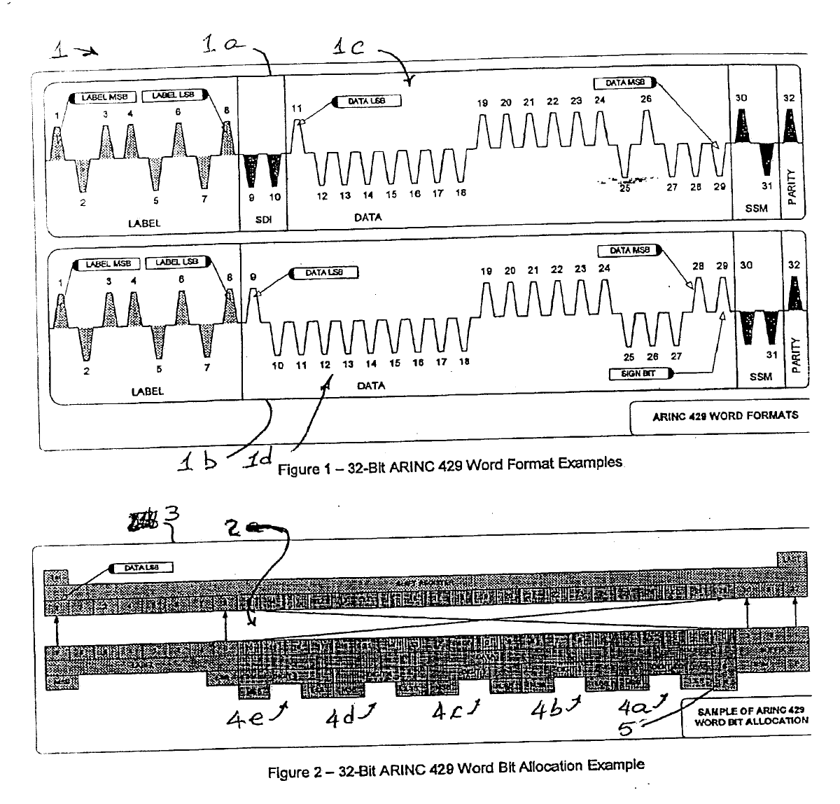

In FIG. 2 is illustrated an example of encoding twenty-one (21) data bits 2 in an ARINC 429 word 3 as five (5) BCD (binary coded decimal) digits 4a-4e and a sign bit 5. In this illustration the BCD digits may represent integer values is within a range of −99,999 to +99,999. In this illustration the order of the twenty-one (21) data bits is in reverse order having the least significant bit (LSB) 4e first prior to transmission as may be the case for some equipment (e.g., system devices 12, which are described further below) that generate the original ARINC data stream in such order; but such order of data is not a general prerequisite for the present invention, e.g., it would not be necessary for a simple data translator or repeater.

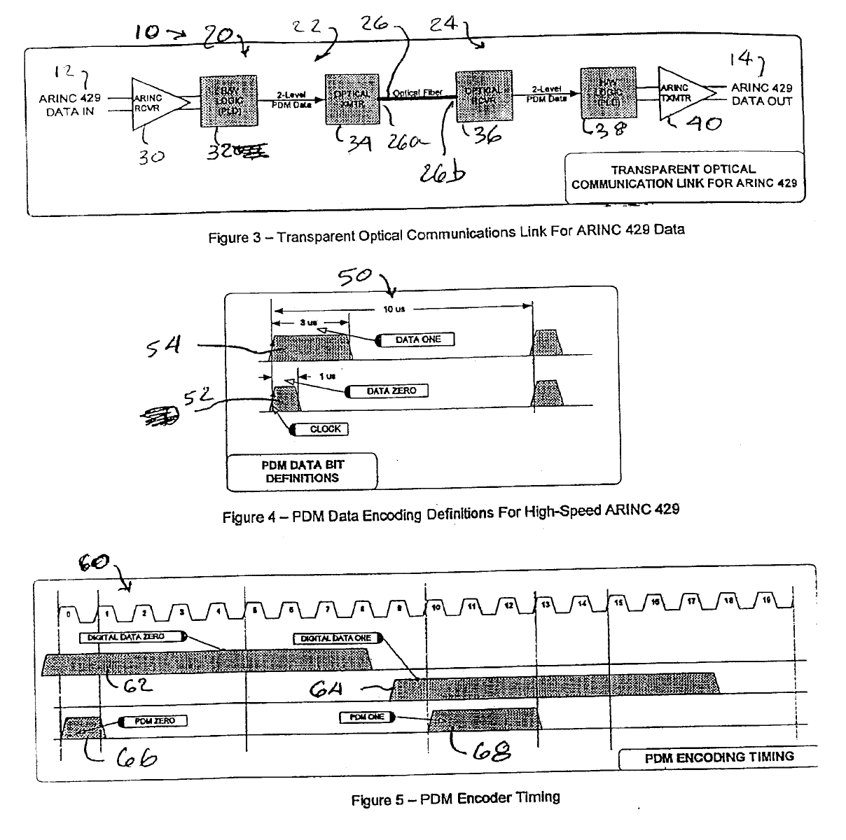

In FIG. 3 an ARINC 429 protocol system or communications system 10 is illustrated. The system 10 includes a pair of ARINC 429 protocol system devices 12, 14, e.g., a sensor and a controller, a sensor and a display, a signaling device and a device responsive to the signals from the signaling device, etc. Such system devices 12, 14 are known ones or are those that may be developed in the future. The system device 12 provides ARINC 429 data, e.g., data that is provided in the ARINC 429 protocol format, to an optical communications link 20; and the system device 14 receives ARINC 429 data from the optical communications link and provides that data for appropriate use, e.g., for a control, display or other function.

The optical communications link 20 in the system 10 couples signals from one system device 12, for example, to the other system device 14. As is described further below, the optical communications link 20 may couple signals in both directions.

The optical communications link 20 includes input logic 22, output logic 24, and an optical link 26 between the input logic and the output logic. The input logic 22 provides optical signals having a duration that corresponds to the level of the electrical signals provided to the input logic. The optical link 26 couples the optical signals from the input logic 22 to the output logic 24. The output logic 24 provides output electrical signals that are of a level representative of the durations of the optical signals such that the electrical signals may be used in a system device of the optical communications system 10. The input logic 22 and the output logic 24 may be relatively remote from each other, e.g., at different locations on an aircraft, e.g., relatively remote from each other, or they may be proximate each other, e.g., even on the same circuit board or in the same electrical housing, etc.

The optical communications link 20 overcomes the two (2) amplitude levels limitation of fiber optics communications, allowing compatibility with electrical systems that have three or more levels, e.g., signals that are positive and negative with respect to ground and ground. The optical communications link 20 encodes the ARINC 429 bit levels into pulse durations, using pulse duration modulation (PDM) or pulse width modulation (PWM). For brevity, reference herein to PDM also includes PWM. This technique allows an ARINC 429 electrical data stream to be transmitted optically in real time with a minimal delay of only a single bit period (e.g., ten (10) microseconds at the high speed rate of 100,000 KBPS (kilobits per second)). Additionally, as will be apparent from the description herein, a processor and the attendant hardware, e.g., memory, input/output connections and/or hardware, and software that may be required for a processor, are not required to encode or to decode the optical data, although, if desired, a processor and the attendant hardware and/or software may be used.

As is described below, the optical communications link 20 also may be used with a multi-level signal system, such as, for example, a 2-level logic system, e.g., a system in which there are ground (or zero (0) volts) and a voltage level other than ground. An example of such a 2-level system is one that uses a binary data stream, e.g., TTL, etc.

In the optical communications link 20 the conversions can be performed via hardware logic, for example, in a CPLD (complex programmable logic device), FPGA (field programmable gate array), or other hardware device. Such hardware devices do not require the type of software as typically is required for a processor based system—the costs, complexity, and qualification requirements for such software and possibly also for the processor, therefore, may be avoided.

The data stream provided to and by the optical communications link 20 is self-clocking. The data stream in the optical communications link only requires a single optical fiber for unidirectional transmission (and, as is described further below, that single optical fiber may be used for bidirectional transmission). Moreover, the data stream generated by the optical communications link is easily filterable to eliminate noise.

As is illustrated in FIG. 3, a system device 12 provides ARINC 429 data, e.g., 3-level data, to an ARINC receiver 30. The ARINC receiver 30 converts the 3-level ARINC 429 data stream to a 2-level logic-compatible data stream, e.g., TTL-compatible data (transistor-transistor logic) or equivalent (or some other data stream that is of suitable 2-level form). In FIG. 3 the input logic 20 is illustrated as including hardware logic 32, such as a PLD. The PLD may be a CPLD (complex programmable logic device), a FPGA, or some other device, devices, arrangement of connections, etc. Such hardware logic devices are commercially available from several sources; these or new ones that are developed in the future may be used. An optical transmitter 34 is coupled to the hardware logic 32. In response to electrical signals from the hardware logic 32, the optical transmitter 34 provides optical signals. The optical signals may be light in the visible spectrum and/or in the non-visible spectrum, e.g., infrared, ultraviolet or some other spectrum or part of the spectrum, at one or more wavelengths. An exemplary optical transmitter is a light emitting diode (LED), a laser diode, or some other device or mechanism that provides the desired light output.

In the description herein, the input logic 22 may be considered solely the hardware logic 32, and the input logic 22 also may be considered the hardware logic 32 together with the ARINC receiver 30 and/or the optical transmitter 34, as will be evident from the operational description below. The ARINC receiver 30 converts the ARINC 429 data stream, e.g., received from the system device 12, to a 2-level logic-compatible data stream of electrical signals. The hardware logic of the hardware logic device 32, e.g., a PLD, converts the ARINC bits into PDM data, e.g., electrical signals that have a pulse duration modulation format such that the durations of respective pulses or of prescribed portions thereof represent or correspond to the ARINC 429 data. This PDM data (electrical signals) then drives the optical transmitter 34 that transmits optical data on the optical link 26. Such optical data may be optical signals that have PDM characteristics that represent or correspond to the PDM character of the PDM data electrical signals from the PLD 32 so that such optical signals represent or correspond to the input ARINC data provided to the ARINC receiver 30.

Optical signals are coupled by the optical link 26 to the output logic 24. The optical link 26 may be a single optical fiber or, if desired, e.g., for redundancy, several optical fibers. The optical link 26 may be or may include other optical devices in addition to or in place of the illustrated optical fiber, such as, for example, light transmitting and/or directing devices, e.g., reflectors, lenses, etc., that direct light in a desired light path, direction, etc.

As also is illustrated in FIG. 3, light from the optical link 26 is provided to an optical receiver 36. In response to optical signals from the optical link 26 the optical receiver provides electrical signals. As the optical signals input to the optical receiver 36 are in the form as PDM signals, the electrical output from the optical receiver also is in the form of PDM electrical signals. Those electrical signals may be standard logic level signals or data, e.g., 2-level signals such as TTL-compatible data or some other suitable data format signals. In the output logic 24 the 2-level signals from the optical receiver 36 are provided to a hardware logic device 38, e.g., a PLD, CPLD, FPGA, etc., as was described above with respect to the hardware logic 32. The hardware logic device 38 converts the PDM electrical signals from the optical receiver 36 into a standard digital data stream of electrical signals, and that data stream is provided an ARINC transmitter 40 to output ARINC 429 signal levels that in turn may be coupled to the ARINC 429 system device 14 or may be otherwise appropriately coupled, used, etc.

The hardware logic 32, 38 may be other solid state devices or systems.

In the description herein, the output logic 24 may be considered solely the hardware logic 38, and the output logic 24 also may be considered the hardware logic 38 together with the optical receiver 36 and/or the ARINC transmitter 40. The optical receiver 36 may be a photosensor, photodiode, or some other device that in response to the optical input thereto provides electrical output. The hardware logic 38 may be a commercially available PLD, CPLD, FPGA, or some other logic device that currently exists or that may be developed in the future. The ARINC transmitter 40, as well as the ARINC receiver 30, may be conventional electrical and/or electronic devices, e.g., amplifiers, logic devices, circuitry, etc., that, convert electrical signals between the ARINC 429 protocol format and standard 2-level, logic compatible data.

Summarizing operation of the optical communications link 20 in an ARINC 429 communications system 10, the ARINC receiver 30 converts the 3-level ARINC 429 data stream to a 2-level logic-compatible data stream. The hardware logic in the PLD 32 converts the ARINC bits into PDM data. This PDM data then drives the optical transmitter 34 that provides PDM optical data (or optical signals) to one end 26a, e.g., the input end of the optical fiber of the optical link 26. The optical signals are transmitted via the optical link 26, e.g., the optical fiber, to the other end 26b thereof, e.g., the output end. The optical receiver 26 optically coupled to the output end 26b converts the optical data into electrical PDM data. This is then converted into a standard electrical digital data stream via the PLD 38, which drives the ARINC transmitter 40 to output ARINC 429 signal levels. Those output ARINC 429 signal levels may be provided a further ARINC 429 system device 14.

It will be appreciated that the system or block diagram illustrated in FIG. 3 is somewhat simplified from the totality of the circuit that includes the components described above for the optical communications link 20 of the invention. Those who have ordinary skill in the art, e.g., electrical and electronics engineers, for example, pertaining to systems of the type described, would be able to prepare the appropriate circuits, connections, power supplies, clock signals, etc. and the appropriate logic set up for the input and output logic 22, 24, e.g., the PLDs 32, 38, to carry out the functions described herein.

FIG. 4 shows an example of the PDM data encoding definitions for (high-speed ARINC 429 data at 100 KBPS (100 kilobits per second). Such encoding may be carried out using the input logic 20, e.g., the PLD 32 of the optical communications line 20 (FIG. 3). Each bit period is ten (10) microseconds long, as is illustrated at 50. In the illustrated example, a data zero bit is encoded as only one (1) microsecond long, as is illustrated at 52, while a data one (1) bit is encoded as three (3) microseconds long, as is illustrated at 54. Any reasonable pulse widths can be used, up to the full length of the ten (10) microsecond bit period 50, provided there is a significant difference between the durations (lengths) of the two bits, e.g., zero and one—e.g., a difference that can be reasonably detected and/or used to distinguish between the two bits. It will be appreciated that the bit period 50 may be longer or shorter than the exemplary ten (10) microseconds example presented.

FIG. 5 shows the timing for encoding (transmitting) ARINC 429 data into the PDM data, e.g., using the PLD 32 and/or other portions of the input logic 22. In the exemplary system presented, the PDM data (pulse duration modulation data) is clocked on the rising edge of the data 0 or data 1 bit; and, therefore, the maximum data delay is only one (1) clock period. In the example presented bit periods of a length of ten (10) microseconds are used and a “10×” clock is used. Therefore, for a 100 KBPS (one hundred thousand bits per second, thus, 10 microseconds per bit), the “10× clock” used is a 1 MHZ (1 megahertz) clock (e.g., a clock that provides an output that is 1 microsecond per clock, for example, per clock pulse, clock output, “clock tick,” etc.). The clock pulses are represented at 60 in FIG. 5. In other implementations, a slower or faster clock (other than “10×”) may be used.

As is illustrated in FIG. 5, as soon as the first data bit, e.g., zero (0) or one (1), which are represented at 62 and 64 in FIG. 5, the PDM output goes high, which is represented at 66, 68 in FIG. 5. If the ARINC bit is zero (0), the PDM output goes low after one (1) clock period. If the ARINC bit is one (1), the PDM output goes low after three (3) clock periods. Since the ARINC data is a fixed rate, the PLD 32, for example, sets its output high after every ten (10) clock periods, which corresponds to the ten (10) microseconds length of the bit period, which is mentioned above and is illustrated at 50 in FIG. 4, provided there is a valid ARINC bit input (e.g., zero (0) or one (1)). This conversion does not introduce any jitter into the output PDM data stream. Also, as was mentioned above, the duration of the respective PDM data 0 and 1 signals may be other than one or three clock pulses.

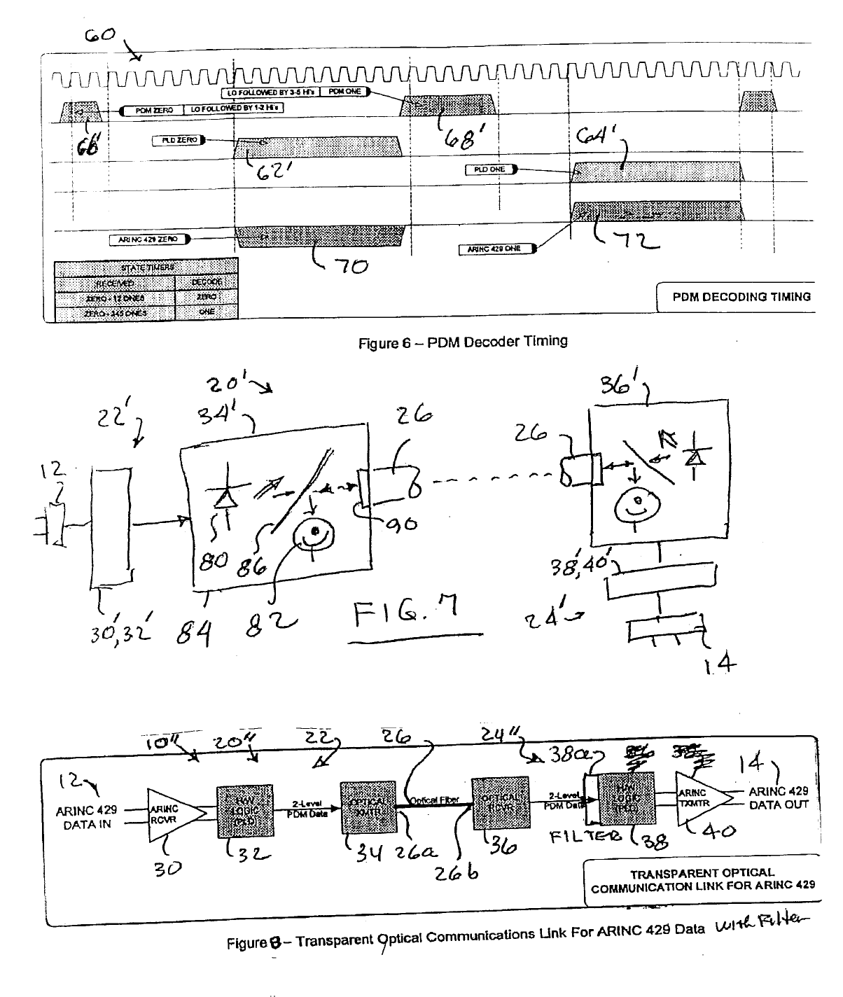

FIG. 6 illustrates the timing for decoding (receiving) PDM data and converting it back to ARINC 429 data, e.g., using the PLD 38 and/or other portions of the output logic 24. Using the above example of one (1) microsecond represents “bit zero (0)” and three (3) microseconds represents “bit one (1),” it will be seen that the delay between receiving a PDM bit 66′, 68′, for example, and generating an ARINC 429 bit (70, 72, for example) is one bit period (ten (10) microseconds) 50. (In the description primed reference numerals are used herein to designate parts, signals, etc. that are the same or similar in structure and/or function to parts, signals, etc. designated by the same unprimed reference numerals.) This delay is due to the decoding logic of the output logic 24. When the decoding logic detects a low-to-high transition in the PDM data 66′, 68′, for example, it starts counting clock periods (clock pulses)—one (1) microsecond each for the “10× clock.” Again, a slower or faster clock (other than “10×”) may be used. If the decoding logic only counts one to two (1-2) periods during the “10× clock” bit interval (of a total of ten microseconds, e.g., as is illustrated at 50 in FIG. 4), the output data is zero (0) (e.g., as is illustrated at 62′ and 70). If it counts three to five (3-5) clock periods, the data output data is one (1) (e.g., as is illustrated at 64′ and 72). By looking at the entire 10 microsecond bit interval, erroneous data and noise can be filtered out. In a similar fashion, if PDM pulses are widened due to optical dispersion, which is common over long, multimode fibers, the system can still detect valid bits. This then introduces a decoding delay of 1 bit interval and provides in effect self-filtering of the effect of optical dispersion.

There are other means of encoding and decoding PDM data to generate signals similar to those in FIG. 4. The above description presents on exemplary approach to each of encoding and decoding. Additionally, as was mentioned above, if the communications system 10 or equipment associated therewith already incorporates a processor, the processor may be used for encoding or decoding PDM data, as primarily a software algorithm.

In FIG. 7 is illustrated an exemplary bidirectional implementation of the invention. In the optical communications link 20′ bidirectional optical transceivers 34′, 36′ are used at opposite ends of the fiber optic link 26, e.g., an optically conductive or light conductive fiber. Examples of such bidirectional optical transceivers are sold under the model numbers MF699 and MF799 by Zarlink. An exemplary bidirectional transceiver includes a light outputting device 80, e.g., an LED or laser diode or some other light source, and a photosensor 82, e.g., a photodiode or some other light sensing device. As an example, the light outputting device and the photosensor may be in a common package or housing 84; and they may be positioned relative to a beam splitter 86 via which light is provided to or received from the optical link 26, e.g., via an opening, window or the like 90 in the housing 84. The two bidirectional optical transceivers 34′, 36′ may be selected such that the light provided by one is of a different wavelength (or other distinguishable characteristic) than the light provided by the other; and the photosensor of one is responsive to light having the wavelength (or other distinguishable characteristic) of the other, and vice versa (exemplary distinct wavelengths are 820 nm (nanometers) and 1330 nm, although others may be used, if desired). Therefore, for example, light of one wavelength provided by one bidirectional optical transceiver may be transmitted in the optical link and be detected by the photosensor of the other bidirectional optical transceiver, and vice versa. Using this approach, only a single optical link is needed to obtain bidirectional communication between two system devices associated with an ARINC 429 optical communications system using the optical communications link 20. In a bidirectional system, e.g., as is illustrated and described here, the input logic 22′ and the output logic 24′ may be the same as that described with respect to the input and output logic 22, 24 above, with the portions thereof operative to work on signals in both directions. As another alternative, the input logic 22′ and output logic 24′, including the parts thereof, such as the ARINC receiver 30′, hardware logic 32′, hardware logic 38′ and ARINC transmitter 40′ may include duplicate portions, one set of portions for signals that are to be provided from the transceiver 34′ via the optical link 26 to the transceiver 36′ and the other set of portions for signals that are to be provided via the optical link 26 from the transceiver 36′ to the transceiver 34′.

The described technique of encoding electrical signals as pulse duration modulation optical signals is also applicable to conventional two-level data communications protocols. The two level data may be, for example, conventional TTL type data, e.g., as in a conventional binary data stream in which voltage levels of zero or ground, on the one hand, and a voltage level other than zero or ground are used. Operation of such a system may be, for example, as was described above. In such case devices such as the ARINC receiver 30 and the ARINC transmitter 40 may be unnecessary and the input data may be provided directly to the PLD or the like 32 in the input logic 22 and provided out from the PLD 38 or the like in the output logic 24. The electrical signals would be converted to PDM optical signals for transmission via the optical link 26 and the signals received from the optical link 26 may be converted back to electrical signals, e.g., as was described above.

In the several embodiments illustrated and described the optical communications link 20, 20′ may be inserted in an ARINC 429 communications system and is substantially transparent or fully transparent to operation of the ARINC 429 system devices 12, 14.

An advantage in using the technique of the present invention, whether with 2-level data, 3-level data or some other data format or protocol, is the ease of filtering the data to remove high-frequency noise. A simple low-pass filter that allows the narrowest PDM pulse to pass through the system will remove high-frequency noise and “glitches” from the receiver end of the data link. Phase distortion or pulse rounding produced by such a filter would be ignored by the decoding logic, e.g., the output logic 24, for example, including the PLD 38. From a commercial consideration, for example, this improved noise immunity would justify the more complex electronics (e.g., a PLD or similar device) that encodes and decodes the data.

In FIG. 8 an example of a communications system 10″ using an optical communications link 20″ with a filter 38a, as was described just above, is illustrated. The filter 38a filters data upstream of the hardware logic 38, e.g., the PLD, in the output logic 24″.

If the data link, e.g., the optical communications link 20, is required to operate at very high data rates but not in “real time” (e.g., a significant delay between transmission and reception is acceptable), the input logic 22 that encodes data, e.g., the hardware logic (for example, the PLD 32) can also lower the data rate to improve noise immunity and allow for additional filtering. The output logic 24 that decodes data, e.g., the hardware logic (for example, the PLD 38) could then regenerate the received data at its original higher rate.

In view of the foregoing, it will be appreciated that the invention may be used to couple or to communicate signals or to couple signals in an ARINC 429 communications system and/or in other communications or signaling systems. It also will be appreciated that the invention may be used to couple or to communicate signals in formats and at different levels and/or protocols than ARINC 429.

1. An optical communications link, comprising
input logic receiving electrical communications signals and providing optical output signals of respective durations corresponding to the respective electrical communication signals,
output logic receiving such optical output signals and providing electrical signals corresponding to the durations of the respective optical output signals, and
an optical link between the input logic and the output logic.

2. The optical communications link of claim 1, wherein at least on of the input logic and output logic is hardware logic.

3. The optical communications link of claim 2, wherein the input logic and the output logic are hardware logic comprising a PLD or FPGA.

4. The optical communications link of claim 1, wherein the optical link comprises an optically conductive fiber.

5. The optical communications link of claim 1, further comprising a light input device providing light input to the, and further comprising a light output device to provide light to the optical link, and a light sensing device to sense light from the optical link.

6. The optical communications link of claim 1, further comprising optical transceivers to provide for bidirectional transmission of optical signals with respect to the optical link.

7. The optical communications link of claim 1, said input logic receiving multi-level electrical communications signals and providing optical output signals of respective durations corresponding to the respective electrical communication signals, and
said output logic receiving such optical output signals and providing multi-level electrical signals corresponding to the durations of the respective optical output signals.

8. An optical communications link for use in an electrical communications system, comprising
a first logic device operative to convert an input signal of a given level to a first electrical signal of a duration corresponding to such level,
a first optical device (transmitter) presenting an optical signal of a duration corresponding to such first electrical signal,
a second optical device (receiver) operative to convert the optical signal to a second electrical signal of a duration representative of the duration of the optical signal,
an optical coupling between the first and second optical devices, and
a second logic device operative to convert the second electrical signal to an output electrical signal having a level that is representative of the duration of the optical signal.

9. The optical communications link of claim 8, wherein the optical coupling comprises at least one of fiber optic, space, lens, mirror, or reflector.

10. The optical communications link of claim 8, wherein at least one of the logic devices is hardware logic.

11. The optical communications link of claim 8, wherein the logic devices are hardware logic.

12. The optical communications link of claim 8, wherein the optical devices are transceivers, and wherein the optical coupling provides for bidirectional transmission of optical signals.

13. The optical communications link of claim 12, further comprising further logic to encode and to decode and to convert optical signals transmitted by the optical coupling from the second optical device to the first optical device.

14. An ARINC 429 communications system for an aircraft, comprising
an electrical signaling device providing electrical signals based on ARINC 429 protocol,
an electrical signal device either proximate or relatively remote from the electrical signaling device and responsive to electrical signals based on ARINC 429 protocol, and
an optical communications link between the electrical signaling device and the electrical signal device to communicate between the two using optical signals that have respective durations representative of the level of such electrical signals.

15. The communications system of claim 14, said optical communications link being independent of a processor and processor software.

16. The communications system of claim 14, said optical communications link providing bidirectional communication.

17. The communications system of claim 14, said optical communications link comprising
a first logic device operative to convert an input signal of a given level to a first electrical signal of a duration corresponding to such level,
a first optical device presenting an optical signal of a duration corresponding to such first electrical signal,
a second optical device operative to convert the optical signal to a second electrical signal of a duration representative of the duration of the optical signal,
an optical coupling between the first and second optical devices, and
a second logic device operative to convert the second electrical signal to an output electrical signal having a level that is representative of the duration of the optical signal.

18. The communications system of claim 17, said logic devices comprising hardware logic.

19. A method of converting electrical signals that are provided at 3 or more levels in and/or for use in an electrical communications system or other electrical signaling system to optical signals, comprising
converting and/or representing the electrical signals as optical signals that have a duration respectively representative of the corresponding electrical signal level.

20. The method of claim 19, wherein said converting and/or representing comprises converting ARINC 429 protocol signals to optical signals, coupling the optical signals to a receiver using an optical link, and converting optical signals from the optical link to ARINC 429 electrical signals.

21. The method of claim 20, both said converting steps being carried out using hardware logic independent of a processor.

22. The method of claim 19, said converting and/or representing comprising converting electrical signals to a binary data stream, converting the signals in the binary data stream to pulse duration modulated electrical signals, converting the pulse duration modulated electrical signals to pulse duration modulated optical signals.

23. The method of claim 22, further comprising transmitting the pulse duration modulated optical signals, converting the pulse duration modulated optical signals to pulse duration modulated electrical signals, decoding the pulse duration modulated electrical signals to a binary data stream, and converting the binary data stream to electrical signals having 3 or more levels following a protocol of the first-mentioned electrical signals.

24. A method of converting electrical signals to optical signals, comprising sensing the level of respective electrical signals, and providing optical signals that have a duration representative of the corresponding electrical signal.
